(19) United States
(12) Patent Application Publication
(10) Pub. No.: US 2025/0392011 A1
(43) Pub. Date: Dec. 25, 2025

(54) BATTERY CELLS AND METHODS FOR MAKING THE SAME

(71) Applicant: GM GLOBAL TECHNOLOGY OPERATIONS LLC, Detroit, MI (US)

(72) Inventors: Arun Chitikela, Novi, MI (US); Subrahmanyam Goriparti, Troy, MI (US); SriLakshmi Katar, Troy, MI (US); Chinar S. Ghike, Farmington Hills, MI (US); Andrew P. Oury, Troy, MI (US)

(73) Assignee: GM GLOBAL TECHNOLOGY OPERATIONS LLC, Detroit, MI (US)

(21) Appl. No.: 18/749,680

(22) Filed: Jun. 21, 2024

(51) Int. Cl. H01M 50/528; H01M 10/04; H01M 50/119; H01M 50/124; H01M 50/30; H01M 50/547

(52) U.S. Cl. CPC H01M 50/528; H01M 10/049; H01M 50/119; H01M 50/1245; H01M 50/30; H01M 50/547

(57) ABSTRACT

A battery cell includes a first electrode, a second electrode, and a separator that is disposed between the first and second electrodes. The separator is electrically insulating and ionically conductive. An electrolyte is operatively disposed between the first and second electrodes and interfaces with the separator to conduct ions between the first and second electrodes. A can is disposed about the first and second electrodes. The first electrode is electrically coupled to the can and the second electrode is electrically isolated from the can. A terminal is disposed adjacent to the can and is accessible from outside of the can. The second electrode is electrically coupled to the terminal.

### INTRODUCTION

The disclosure generally relates to battery cells including a first electrode electrically coupled to a battery cell can and a second electrode electrically coupled to a battery cell terminal.

Battery cells may include an anode, a cathode, and an electrolyte. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

### SUMMARY

A battery cell in accordance with one or more embodiments is provided. The battery cell includes a first electrode, a second electrode, and a separator that is disposed between the first and second electrodes. The separator is electrically insulating and ionically conductive. An electrolyte is operatively disposed between the first and second electrodes and interfaces with the separator to conduct ions between the first and second electrodes. A can is disposed about the first and second electrodes. The first electrode is electrically coupled to the can and the second electrode is electrically isolated from the can. A terminal is disposed adjacent to the can and accessible from outside of the can. The second electrode is electrically coupled to the terminal.

In some embodiments, the first electrode is a cathode and the second electrode is an anode.

In some embodiments, the cathode includes aluminum or an alloy thereof and the can includes aluminum or an alloy thereof.

In some embodiments, the first electrode is an anode and the second electrode is a cathode.

In some embodiments, the anode includes copper or an alloy thereof and the can includes stainless steel.

In some embodiments, the stainless steel has a nickel plating disposed thereon.

In some embodiments, the first electrode is welded directly to the can.

In some embodiments, the battery cell further includes a metal plate that is disposed between the first electrode and the can. The first electrode is directly welded to the metal plate and the metal plate is directly welded to the can.

In some embodiments, the metal plate includes aluminum or an alloy thereof.

In some embodiments, the battery cell has a vent that is disposed along a first side of the battery cell and that is configured to selectively release gas from inside of the can to outside of the can.

In some embodiments, the terminal is disposed along the first side of the battery cell adjacent to the vent.

In some embodiments, the battery cell has a second side that is disposed adjacent to the first side and the terminal is disposed along the second side of the battery cell.

A method for making a battery cell in accordance with one or more embodiments is provided. The method includes providing a first electrode having an electrode coated active area and an electrode uncoated area that extends from the electrode coated active area. The method further includes slitting, kneading, and/or bending the electrode uncoated area to form one or more electrode tabs coupled to the electrode coated active area. The method further includes disposing a separator between the first electrode and a second electrode. The separator is electrically insulating and ionically conductive. The method further includes operatively disposing an electrolyte between the first and second electrodes and interfacing with the separator to conduct ions between the first and second electrodes. The method further includes disposing the first and second electrodes including the separator and the electrolyte in a can. The method further includes coupling the one or more electrode tabs to the can such that the first electrode is electrically coupled to the can. A method further includes electrically coupling the second electrode to a terminal and disposing the terminal adjacent to the can and accessible from outside of the can.

In some embodiments, the electrode uncoated area extends a distance of about 3 to about 5 mm from the electrode coated active area.

In some embodiments, the electrode uncoated area is formed into a plurality of electrode tabs via slitting and then kneading the electrode uncoated area.

In some embodiments, the electrode uncoated area is formed into the one or more electrode tabs by bending the electrode uncoated area towards the electrode coated active area and holding the electrode uncoated area against the electrode coated active area with spaced apart sections of tape.

In some embodiments, coupling the one or more electrode tabs to the can includes using a welding process.

In some embodiments, coupling the one or more electrode tabs to the can includes using the welding process to directly weld the one or more electrode tabs to the can.

In some embodiments, coupling the one or more electrode tabs to the can includes disposing a metal plate between the one or more electrode tabs and the can, and using the welding process to directly weld the one or more electrode tabs to the metal plate and to directly weld the metal plate to the can.

A vehicle in accordance with one or more embodiments is provided. The vehicle includes an output device. A battery cell is configured to provide electrical energy to the output device. The battery cell includes a first electrode, a second electrode, and a separator disposed between the first and second electrodes. The separator is electrically insulating and ionically conductive. An electrolyte is operatively disposed between the first and second electrodes and interfaces with the separator to conduct ions between the first and second electrodes. A can is disposed about the first and second electrodes. The first electrode is electrically coupled to the can and the second electrode is electrically isolated from the can. A terminal is disposed adjacent to the can and accessible from outside of the can. The second electrode is electrically coupled to the terminal.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 illustrates a schematic view of a vehicle that includes a battery system with battery cells and an output device in accordance with an exemplary embodiment.

FIG. 2 illustrates, in cross sectional view, a battery cell in accordance with the present disclosure.

FIG. 3A illustrates, in cross sectional view, a battery cell in accordance with the present disclosure.

FIG. 3B illustrates, in cross sectional view, a portion of the battery cell depicted in FIG. 3A in accordance with an alternative embodiment.

FIG. 4A illustrates a method for making a battery cell in accordance with the present disclosure.

FIG. 4B illustrates a method for making a battery cell in accordance with an alternative embodiment.

FIG. 5 illustrates a method for making a battery cell in accordance with the present disclosure.

FIG. 6 illustrates a method for making a battery cell in accordance with the present disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about.”

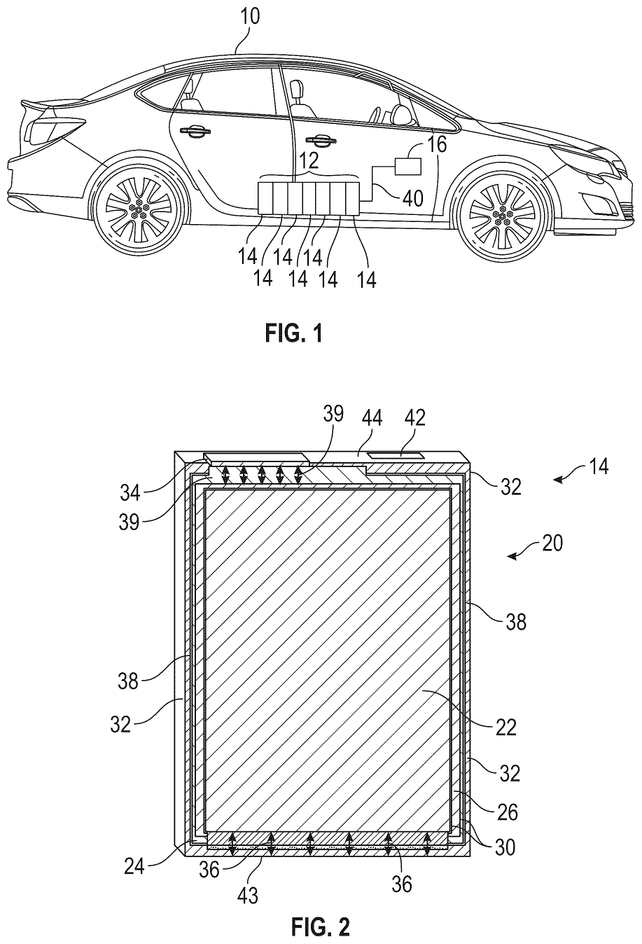

FIG. 1 schematically illustrates an exemplary device 10, e.g., a battery electric vehicle (BEV), including a battery pack 12 that includes a plurality of battery cells 14. Although the battery cells 14 are illustrated as being utilized in a BEV, it is to be understood that the battery cells 14 may be utilized in a wide range of applications and powertrains. The plurality of battery cells 14 may be connected in various combinations, for example, with a portion being connected in parallel and a portion being connected in series, to achieve goals of supplying electrical energy at a desired voltage. The battery pack 12 is illustrated as electrically connected to a motor generator unit 16 (e.g., output device) useful to provide motive force to the vehicle 10. The motor generator unit 16 may include an output component, for example, an output shaft, which transfers mechanical energy useful to provide the motive force to the vehicle 10. A number of variations to vehicle 10 are envisioned, and the disclosure is not intended to be limited to the examples provided.

FIG. 2 schematically illustrates, in cross sectional view, an exemplary battery cell 14 of the battery pack 12. Referring to FIGS. 1 and 2, in an exemplary embodiment, the battery cell 14 is configured as a lithium-ion battery 20. The lithium-ion battery 20 includes a first electrode 22 (e.g., positive or negative electrode), a second electrode 24 (e.g., the other of the positive or negative electrode), and a separator 26 (e.g., a microporous or nano-porous polymeric separator) disposed between the first and second electrodes 22 and 24. An electrolyte 30 is disposed between the first and second electrodes 22 and 24 and interfaces with the separator 26, for example, the electrolyte 30 is disposed in pores of the separator 26. The electrolyte 30 may also be present in the first electrode 22 and second electrode 24, such as in their pores.

The separator 26 operates as both an electrical insulator and a mechanical support. More particularly, the separator 26 is disposed between the first electrode 22 and the second electrode 24 to prevent or reduce physical contact and thus, the occurrence of a short circuit. The separator 26, in addition to providing a physical barrier between the two electrodes 22 and 24, provides a minimal resistance path for internal passage of lithium ions (and related anions) during cycling of the lithium ions to facilitate functioning of the lithium-ion battery 20.

A can 32 (e.g., prismatic can cell, battery envelope or metal battery encasing) is disposed about the first and second electrodes 22 and 24. Disposed adjacent to the can 32 and accessible from outside the can 32, is a terminal 34. In an exemplary embodiment, the first electrode 22 is electrically coupled to the can 32 along a region (indicated by double headed arrows 36). The second electrode 24 is electrically coupled to the terminal 34 by a tab or current collector (indicated by double headed arrows 39) while being electrically isolated from the can 32 by a dielectric 38 (e.g., open-space/gap or a layer of low dielectric constant material).

In an exemplary embodiment, the battery cell 14 has a vent 42 that is disposed along a side 44 (e.g., upper side) of the battery cell 14. The vent 42 is sized and/or otherwise configured to selectively release gas from inside of the can 32 to outside of the can 32, for example, to prevent gas from building up within the battery cell 14. As illustrated, the terminal 34 is disposed along the side 44 of the battery cell 14 adjacent to the vent 42 while the first electrode 22 is electrically coupled to the can 32 along region 36 on a side 43 that is opposite the side 44.

In one embodiment, the first electrode 22 is a cathode and the second electrode 24 is an anode. In this embodiment, the cathode includes aluminum or an alloy thereof (e.g., as a support structure that is partially coated with the cathode active material and that has an uncoated area extending therefrom) and the can 32 includes or is otherwise formed of aluminum or an alloy thereof. In this example, the cathode (e.g., the first electrode 22) is welded directly to the can 32, or alternatively, may be welded indirectly to the can 32 as will be discussed in further detail below.

In another embodiment, the first electrode 22 is an anode and the second electrode 24 is a cathode. In this embodiment, the anode includes copper or an alloy thereof (e.g., as a support structure that is partially coated with the anode active material and that has an uncoated area extending therefrom) and the can 32 includes or is otherwise formed of stainless steel. Further, the stainless steel may have a nickel plating disposed thereon. In this example, the anode (e.g., the first electrode 22) is welded directly to the can 32, or alternatively, may be welded indirectly to the can 32 as will be discussed in further detail below.

In an exemplary embodiment, the lithium-ion battery 20 can generate an electric current during discharge by way of reversible electrochemical reactions that occur when the circuit 40 is closed to electrically connect the anode and cathode when the anode contains a relatively greater quantity of cyclable lithium. The chemical potential difference between the cathode and the anode drives electrons produced by the oxidation of lithium (e.g., intercalated/alloyed/plated lithium) at the anode through the circuit 40, connected for example by the terminal 34, toward the cathode, which is connected for example to the circuit 40 by the can 32. Lithium ions, which are also produced at the anode, are concurrently transferred through the electrolyte 30 and separator 26 towards the cathode. The electrons flow through the circuit 40 and the lithium ions migrate across the separator 26 in the electrolyte 30 to intercalate/alloy/plate into a positive electroactive material of the cathode. The electric current passing through the circuit 40 can be harnessed and directed through the motor generator unit 16 until the lithium in the anode is depleted and the capacity of the lithium-ion battery 20 is diminished. The lithium-ion battery 20 can be charged or re-energized at any time by connecting an external power source (e.g., charging device) to the lithium-ion battery 20 to reverse the electrochemical reactions that occur during battery discharge.

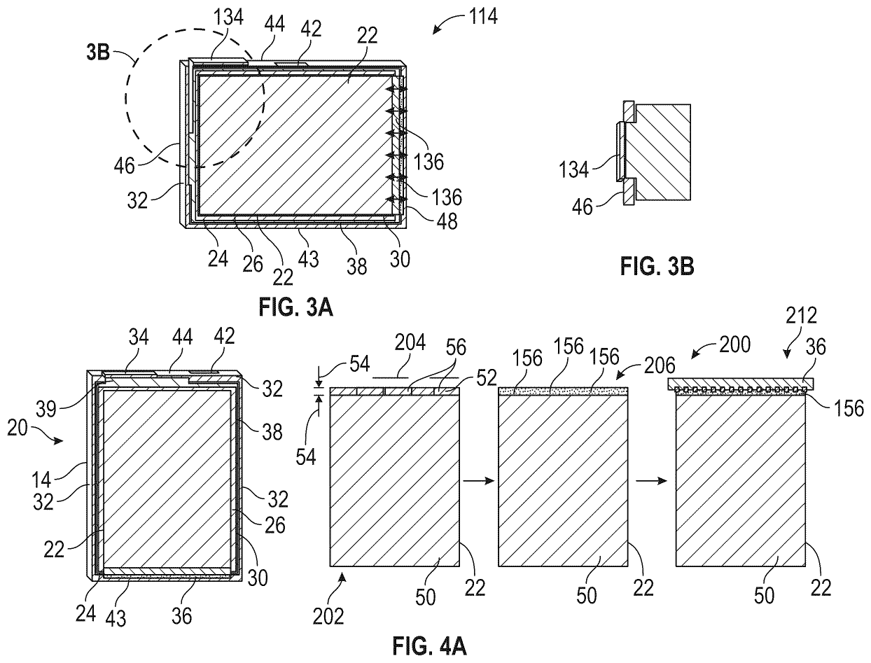

FIG. 3A illustrates, in cross sectional view, a battery cell 114 that is similarly configured to the battery cell 14 illustrated in FIG. 2 including the first electrode 22, the second electrode 24, the separator 26, the electrolyte 30, the can 32, and the vent 42 but with the exception of the terminal 134 and the region 136 are differently configured. Regarding the terminal 134, the terminal 134 is configured as an “L-shaped” conductive structure as opposed to the flat-plate conductive structure of the terminal 34 illustrated in FIG. 2. In particular, one leg of the “L-shaped” terminal 134 is disposed along the side 44 of the battery cell 114 while the other leg of the “L-shaped” terminal 134 is disposed along a side 46 that is adjacent to the side 44. Alternatively, and with reference to FIG. 3B, the terminal 134 may be configured as a flat-plate conductive structure that is disposed along the side 46 that is adjacent to the side 44.

Referring back to FIG. 3A, in an exemplary embodiment, the first electrode 22 is electrically coupled to the can 32 along region 136 on a side 48 that is opposite the side 46. Further, it is noted that the battery cell 114 has a different shape than the battery cell 14 illustrated in FIG. 2. As such, the battery cells 14, 114 may have different sizes and shapes, for example, as is the case with various prismatic can cells and other battery cell designs.

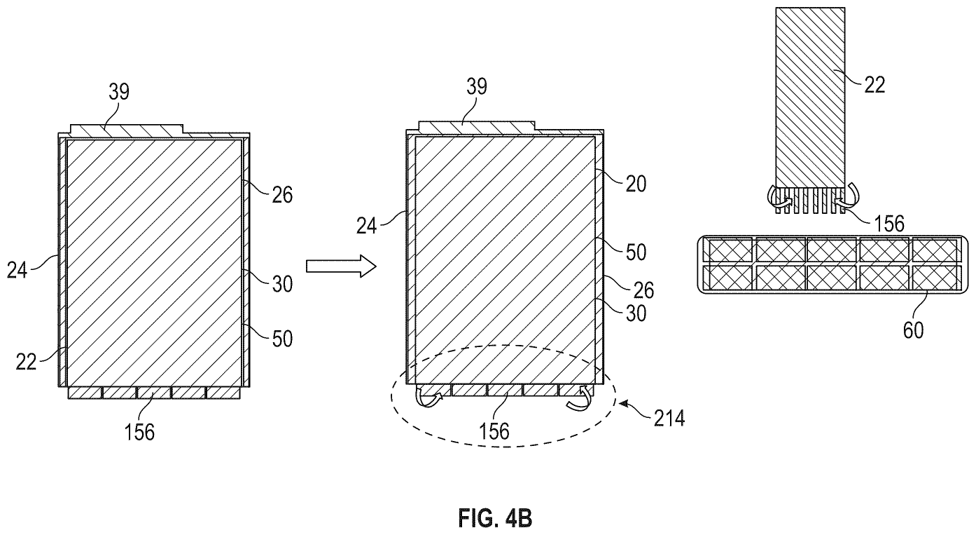

Referring to FIG. 4A, a method 200 for making a battery cell 14 as discussed above in accordance with an exemplary embodiment is provided. The method 200 includes providing (STEP 202) a first electrode 22 having an electrode coated active area 50 and an electrode uncoated area 52 that extends from the electrode coated active area 50. As discussed above, the first electrode 22 may be a cathode, or alternatively, an anode.

In the case of the first electrode 22 configured as a cathode, the cathode may include a thin aluminum or aluminum alloy support structure. The electrode coated active area 50 includes a cathode active material that is coated over a portion of the thin aluminum or aluminum alloy support structure. Examples of cathode active materials include, or consist of a lithium-based active material that can undergo lithium intercalation and deintercalation, alloying and dealloying, while functioning as the positive terminal material of the lithium-ion battery 20. Further, the cathode active material may include a positive electroactive material. Positive electroactive materials may include one or more transition metal cations, such as manganese (Mn), nickel (Ni), cobalt (Co), chromium (Cr), iron (Fe), vanadium (V), and combinations thereof. In this example, the electrode uncoated area 52 includes the thin aluminum or aluminum alloy support structure that is exposed.

In the case of the first electrode 22 configured as an anode, the anode may include a thin copper or copper alloy support structure. The electrode coated active area 50 includes a negative electroactive material that is coated over a portion of the thin copper or copper alloy support structure. The negative electroactive material includes a lithium host material capable of functioning as a negative terminal of the lithium-ion battery 20. Common negative electroactive materials include lithium insertion materials or alloy host materials or plating and stripping materials. Such materials can include carbon-based materials, such as lithium-graphite intercalation compounds, lithium-silicon compounds, lithium-tin alloys, or lithium titanate. In this example, the electrode uncoated area 52 includes the thin copper or copper alloy support structure that is exposed.

In an exemplary embodiment, the electrode uncoated area 52 extends a distance (indicated by arrows 54) of about 3 to about 5 mm from the electrode coated active area 50. The method 200 precedes by slitting (STEP 204) the electrode uncoated area 52 into a plurality of tabs 56. The tabs 56 are then kneaded (STEP 206) (worked or bent) to form electrode tabs 156.

Referring also to FIG. 6, the method 200 further includes disposing (STEP 208) a separator 26 between the first electrode 22 and a second electrode 24. An electrolyte 30 is operatively disposed between the first and second electrodes 22 and 24 and interfaces with the separator 26. The method 200 continues by disposing (STEP 210) the first and second electrodes 22 and 24 including the separator 26 and the electrolyte 30 in a can 32. As illustrated, the second electrode 24 is electrically coupled to a terminal 34.

In an exemplary embodiment, the method 200 continues by placing the can 32 containing the battery cell structure into a welding fixture 58 and the one or more electrode tabs 156 are electrically coupled (STEP 212) to the can 32 using a welding process. In one embodiment and as illustrated, the one or more electrode tabs 156 are directly welded to the can 32. Referring to FIGS. 4B and 6, in an alternative embodiment, the method 200 includes disposing (STEP 214) a metal plate 60 between the one or more electrode tabs 156 and the can 32. Using the welding process, the one or more electrode tabs 156 are directly welded to the metal plate 60, and the metal plate 60 is directly welded to the can 32. In an exemplary embodiment, the metal plate 60 includes or is formed of aluminum or an alloy thereof. As illustrated in FIG. 6, in the fully assembled condition of the battery cell 14, the terminal 34 is disposed adjacent to the can 32 and is accessible from outside of the can 32.

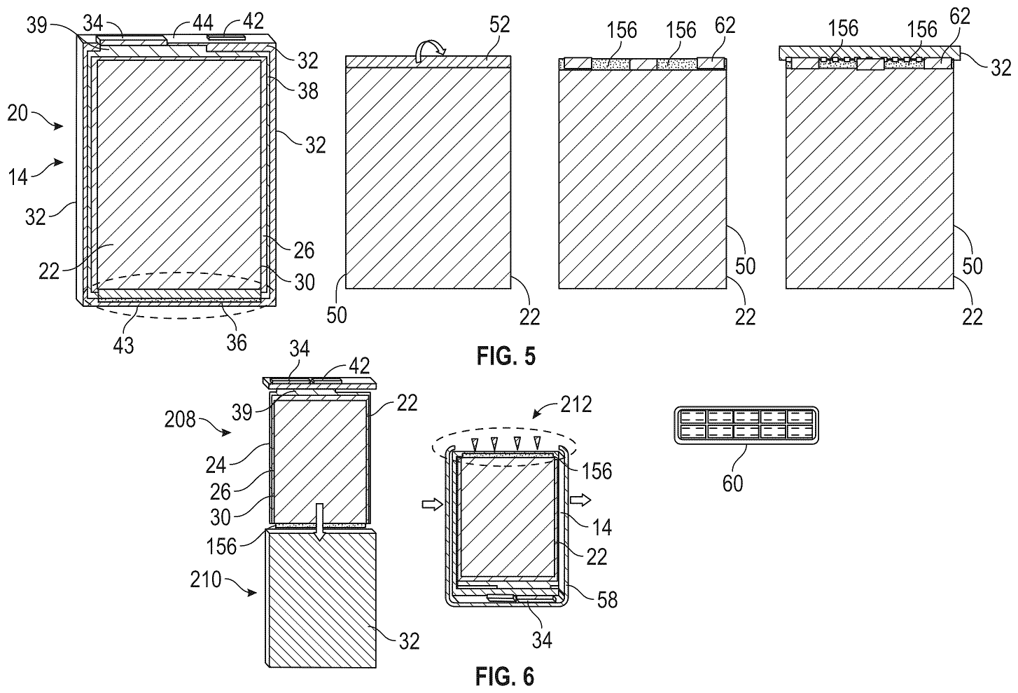

Referring to FIG. 5, in an alternative intermediate fabrication stage, the one or more electrode tabs 156 are formed by bending the electrode uncoated area 52 toward the electrode coated active area 50 and holding the electrode uncoated area 52 against the electrode coated active area 50 with spaced apart sections of tape 62. From there, the method 200 continues as discussed above in relation to FIGS. 4A and 6 to form the battery cell 14.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A battery cell comprising:
a first electrode;
a second electrode;
a separator disposed between the first and second electrodes, wherein the separator is electrically insulating and ionically conductive;
an electrolyte operatively disposed between the first and second electrodes and interfacing with the separator to conduct ions between the first and second electrodes;
a can disposed about the first and second electrodes, wherein the first electrode is electrically coupled to the can and the second electrode is electrically isolated from the can; and
a terminal disposed adjacent to the can and accessible from outside of the can, wherein the second electrode is electrically coupled to the terminal.

2. The battery cell of claim 1, wherein the first electrode is a cathode and the second electrode is an anode.

3. The battery cell of claim 2, wherein the cathode comprises aluminum or an alloy thereof and the can comprises aluminum or an alloy thereof.

4. The battery cell of claim 1, wherein the first electrode is an anode and the second electrode is a cathode.

5. The battery cell of claim 4, wherein the anode comprises copper or an alloy thereof and the can comprises stainless steel.

6. The battery cell of claim 5, wherein the stainless steel has a nickel plating disposed thereon.

7. The battery cell of claim 1, wherein the first electrode is welded directly to the can.

8. The battery cell of claim 1, further comprising a metal plate that is disposed between the first electrode and the can, and wherein the first electrode is directly welded to the metal plate and the metal plate is directly welded to the can.

9. The battery cell of claim 8, wherein the metal plate comprises aluminum or an alloy thereof.

10. The battery cell of claim 1, wherein the battery cell has a vent that is disposed along a first side of the battery cell and that is configured to selectively release gas from inside of the can to outside of the can.

11. The battery cell of claim 10, wherein the terminal is disposed along the first side of the battery cell adjacent to the vent.

12. The battery cell of claim 10, wherein the battery cell has a second side that is disposed adjacent to the first side and the terminal is disposed along the second side of the battery cell.

13. A method for making a battery cell, the method comprising:
providing a first electrode having an electrode coated active area and an electrode uncoated area that extends from the electrode coated active area;
slitting, kneading, and/or bending the electrode uncoated area to form one or more electrode tabs coupled to the electrode coated active area;
disposing a separator between the first electrode and a second electrode, wherein the separator is electrically insulating and ionically conductive;
operatively disposing an electrolyte between the first and second electrodes and interfacing with the separator to conduct ions between the first and second electrodes;
disposing the first and second electrodes including the separator and the electrolyte in a can;
coupling the one or more electrode tabs to the can such that the first electrode is electrically coupled to the can;
electrically coupling the second electrode to a terminal; and
disposing the terminal adjacent to the can and accessible from outside of the can.

14. The method of claim 13, wherein the electrode uncoated area extends a distance of about 3 to about 5 mm from the electrode coated active area.

15. The method of claim 13, wherein the electrode uncoated area is formed into a plurality of electrode tabs via slitting and then kneading the electrode uncoated area.

16. The method of claim 13, wherein the electrode uncoated area is formed into the one or more electrode tabs by bending the electrode uncoated area towards the electrode coated active area and holding the electrode uncoated area against the electrode coated active area with spaced apart sections of tape.

17. The method of claim 13, wherein coupling the one or more electrode tabs to the can comprises using a welding process.

18. The method of claim 17, wherein coupling the one or more electrode tabs to the can comprises using the welding process to directly weld the one or more electrode tabs to the can.

19. The method of claim 17, wherein coupling the one or more electrode tabs to the can comprises:
disposing a metal plate between the one or more electrode tabs and the can; and
using the welding process to directly weld the one or more electrode tabs to the metal plate and to directly weld the metal plate to the can.

20. A vehicle comprising:
an output device; and
a battery cell configured to provide electrical energy to the output device, the battery cell comprising:
a first electrode;
a second electrode;
a separator disposed between the first and second electrodes, wherein the separator is electrically insulating and ionically conductive;
an electrolyte operatively disposed between the first and second electrodes and interfacing with the separator to conduct ions between the first and second electrodes;
a can disposed about the first and second electrodes, wherein the first electrode is electrically coupled to the can and the second electrode is electrically isolated from the can; and
a terminal disposed adjacent to the can and accessible from outside of the can, wherein the second electrode is electrically coupled to the terminal.
